(19) United States
(12) Patent Application Publication
(10) Pub. No.: US 2007/0168197 A1
(43) Pub. Date: Jul. 19, 2007

(54) Audio coding

(75) Inventor: Adriana Vasilache, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/335,168

(22) Filed: Jan. 18, 2006

(51) Int. Cl. G10L 21/04

(52) U.S. Cl. 704/503

(57) ABSTRACT

Coding an audio signals with receiving the input audio signal, splitting the input audio signal into at least two sub-bands, scaling the at least two sub-bands with a scaling factor, quantizing the scaled sub-bands using a conditional split lattice quantizer, wherein the output of the conditional split lattice quantizer is a lattice codevector for each sub-band, and encoding at least the information relating to the scaling factor and the information relating to the number of bits on which the lattice codevectors are represented.

### TECHNICAL FIELD

The application relates in general to audio encoding and decoding technology.

### BACKGROUND

For audio coding, different coding schemes have been applied in the past. One of these coding schemes applies a psychoacoustical encoding. With these coding schemes, spectral properties of the input audio signals are used to reduce redundancy. Spectral components of the input audio signals are analyzed and spectral components are removed which apparently are not recognized by the human ear. In order to apply these coding schemes, spectral coefficients of input audio signals are obtained.

Quantization of the spectral coefficients within psychoacoustical encoding, such as Advanced Audio Coder (AAC) and MPEG audio, was previously performed using scalar quantization followed by entropy coding of the scale factors and of the scaled spectral coefficients. The entropy coding was performed as differential encoding using eleven possible fixed Huffman trees for the spectral coefficients and one tree for the scale factors.

The ideal coding scenario produces a compressed version of the original signal, which results in a decoding process in a signal that is very close (at least in a perceptual sense) to the original, while having a high compression ratio and a compression algorithm that is not too complex. Due to today's widespread multimedia communications and heterogeneous networks, it is a permanent challenge to increase the compression ratio for the same or better quality while keeping the complexity low.

### SUMMARY

According to one aspect, the application provides a method for encoding an input audio signal with receiving the input audio signal, transforming the time domain audio signal into a frequency domain signal, splitting the frequency domain audio signal into at least two sub-bands, scaling the at least two sub-bands with a scaling factor, quantizing the scaled sub-bands using a conditional split lattice quantizer, wherein the output of the conditional split lattice quantizer is a lattice codevector for each sub-band, and encoding at least information relating to the scaling factors, information relating to the number of bits on which the lattice codevector indexes are represented, and information relating to the lattice codevector indexes.

It is possible to further encode at least information relating to a plurality of scaling factors, information relating to the number of bits on which the lattice codevector indexes are represented, and information relating to the lattice codevector indexes.

According to another aspect, the application provides an encoder comprising a transform unit adapted to receive a time domain input audio signal, transform the audio signal into a frequency domain signal, and to split the frequency domain audio signal into at least two sub-bands, a scaling unit adapted to scale at least two sub-bands with a scaling factor, a conditional split lattice quantizer unit adapted to quantize the scaled sub-bands outputting a lattice codevector for each sub-band, and an encoding unit adapted to encode at least information relating to the scaling factor, and information relating to the number of bits on which the lattice codevectors are represented.

The encoding unit can further be adapted to encode at least information relating to a plurality of scaling factors, information relating to the number of bits on which the lattice codevectors are represented, and information related to the lattice codevector indexes.

According to another aspect, the application provides an electronic device comprising a transform unit adapted to receive a time domain input audio signal, transform the audio signal into a frequency domain signal, and to split the frequency domain audio signal into at least two sub-bands, a scaling unit adapted to scale at least two sub-bands with a scaling factor, a conditional split lattice quantizer unit adapted to quantize the scaled sub-bands outputting a lattice codevector for each sub-band, and an encoding unit adapted to encode at least information relating to the scaling factor, and information relating to the number of bits on which the lattice codevectors are represented.

According to another aspect, the application provides a software program product, in which a software code for audio encoding is stored, said software code realizing the following steps when being executed by a processing unit of an electronic device: receive the input audio signal, transform the time domain audio signal into frequency domain, split the frequency domain audio signal into at least two sub-bands, scale the at least two sub-bands with a scaling factor, quantize the scaled sub-bands using a conditional split lattice quantizer, wherein the output of the conditional split lattice quantizer is a lattice codevector for each sub-band, and encode at least information relating to the scaling factor, and information relating to the number of bits on which the lattice codevectors are represented.

Another aspect of the patent application is a method for decoding an encoded audio signal with receiving the encoded audio signal, entropy decoding the encoded audio signal obtaining at least information about the number of bits of lattice codevectors and scaling factors of sub-bands, obtaining, for each sub-band, a codevector index from an encoded bitstream codeword whose length equals the number of bits of the lattice codevector and obtaining the lattice codevector from the codevector index, and re-scaling, for each sub-band, the obtained codevector by applying the scaling factor and obtaining the frequency representation of the audio signal and inverse transforming the frequency representation of the signal into time domain.

A further aspect of the application is a decoder comprising an entropy decoding unit adapted to entropy decode an encoded audio signal obtaining at least information about the number of bits of lattice codevectors and scaling factors of sub-bands, an inverse indexing unit arranged to obtain, for each sub-band, a codevector index from an encoded bitstream codeword of length equal to the number of bits of the lattice codevector and to obtain the lattice codevector from the codevector index, a scaling unit adapted to re-scale, for each sub-band, the obtained codevector by applying the scaling factor, and an inverse transform unit to transform the frequency representation of the signal into time domain.

Yet, a further aspect of the patent application is an electronic device comprising an entropy decoding unit adapted to entropy decode an encoded audio signal obtaining at least information about the number of bits of lattice codevectors and scaling factors of sub-bands, an inverse indexing unit arranged to obtain, for each sub-band, a codevector index from an encoded bitstream codeword of length equal to the number of bits of the lattice codevector and to obtain the lattice codevector from the codevector index, a scaling unit adapted to re-scale, for each sub-band, the obtained codevector by applying the scaling factor, and an inverse transform unit to transform the frequency representation of the signal into time domain.

A further aspect of the application is a software program product, in which a software code for audio decoding is stored, said software code realizing the following steps when being executed by a processing unit of an electronic device: receive the encoded audio signal, entropy decode the encoded audio signal to obtain at least information about the number of bits of lattice codevectors and scaling factors of sub-bands, obtain, for each sub-band, a codevector index from an encoded bitstream codeword whose length equals the number of bits of the lattice codevector and obtain the lattice codevector from the codevector index, re-scale, for each sub-band, the obtained codevector by applying the scaling factor and obtain the frequency representation of the audio signal, and inverse transform the frequency representation of the signal into time domain.

Further aspects of the application will become apparent from the following description, illustrating possible embodiments.

### BRIEF DESCRIPTION OF THE DRAWINGS

FIG. 1 illustrates schematically functional blocks of an encoder of a first electronic device according to an embodiment of the invention;

FIG. 2 is a flow chart illustrating an encoding operation according to an embodiment of the invention;

FIG. 3 is a flow chart illustrating a conditional split lattice coding according to an embodiment of the invention;

FIG. 4 illustrates a Table for obtaining a number of bits for encoding a lattice vector;

FIG. 5 illustrates schematically functional blocks of a decoder of a second electronic device according to an embodiment of the invention;

FIG. 6 is a flowchart illustrating a constrained error criterion optimization process;

FIG. 7 illustrates a lattice truncation with leader vectors and leader classes.

### DETAILED DESCRIPTION OF THE DRAWINGS

The application provides a new structure for the quantization of the MDCT spectral coefficients of audio signals, for example within the AAC framework.

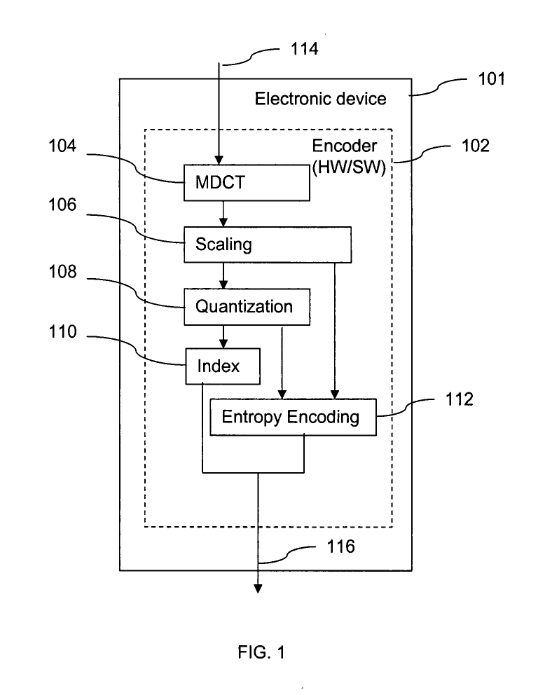

FIG. 1 is a diagram of an electronic device 101, in which an encoding according to embodiments of the application may be implemented.

The electronic device 101 comprises an encoder 102, of which the functional blocks are illustrated schematically. The encoder 102 comprises a modified discrete cosine transform (MDCT) unit 104, a scaling unit 106, a vector quantization unit 108, an indexing unit 110, and an entropy encoding unit 112.

The encoder 102 can be implemented in hardware (HW) and/or software (SW). As far as implemented in software, a software code stored on a computer readable medium realizes the described functions when being executed in a processing unit of the device 101.

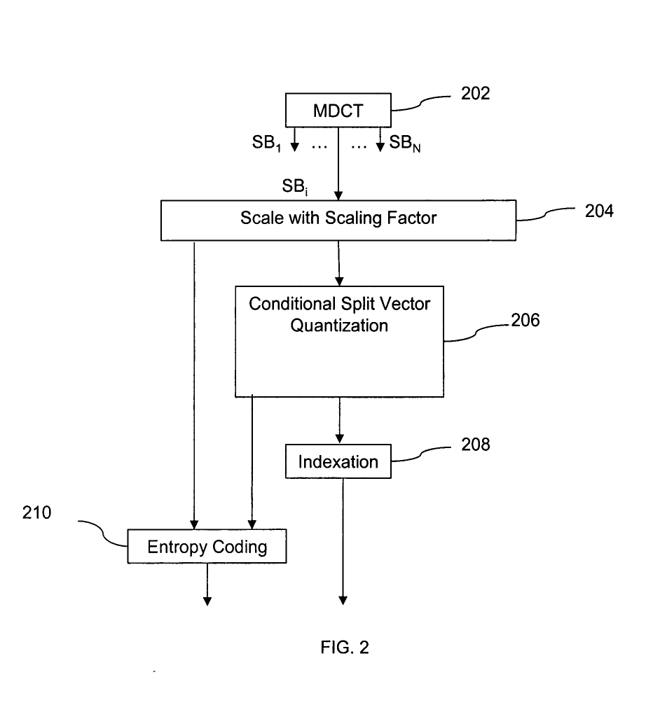

The operation of the electronic device 101 will be described in more detail with reference to FIG. 2.

Within the MDCT unit 104 a time domain input audio signal 114 is MDCT transformed into its frequency domain. The MDCT unit 104 provides spectral components of the input audio signal, which are divided (202) into sub-bands SB₁-SBₙ for each frame of a given number of spectral values, for example 1024 values per frame. The number of spectral values depends on the sampling frequency of the audio signal. Consecutive frames build a representation of the spectral components of the input audio signal.

Then, within the scaling unit 106, the spectral components of a plurality of frequency sub-bands of the frequency domain signal are scaled (204) with a scaling factor s. The scaling factor s for each sub-band is chosen from the set of possible values, larger than the initial value, such that it minimizes the error ratio per sub-band, given the constraint imposed by the available number of bits to encode the information relative to the current frame.

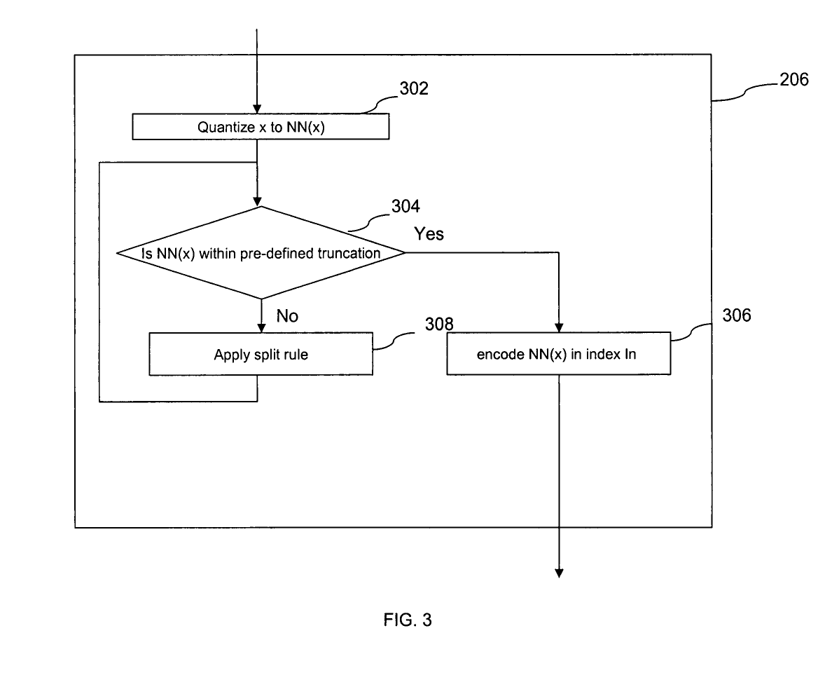

The scaled spectral components are provided to vector quantization unit 108, in which the spectral components are quantized (206) using a conditional lattice quantizer. The conditional split vector quantization will be described in more detail with reference to FIGS. 3-4, and 7.

In each sub-band the spectral coefficients are directly divided by the scale factor (204). For a given sub-band i, the encoded values are the exponents of the scale factors {sᵢ}. The scale factors have, for example, a base of 2 and the exponent {sᵢ}, but other base values may also be possible.

The result of the division is input to the conditional split lattice vector quantization (206) within quantization unit 108. The operation of the conditional split lattice vector quantization (206) will be described later in more detail and illustrated in FIG. 3. The vector quantizer 108 may have a dimension equal to the size of each sub-band. The sub-bands dimensions may, for instance, be 4, 8, 12, 16, 20 . . . and the dimensions of the vector quantizer per sub-band equals the dimension of the sub-band. The output of the conditional split lattice vector quantization (206) for the sub-band i is a set of lattice codevector indexes {Iⱼ⁽ⁱ⁾} and the information related to the number of bits on which the lattice codevector indexes are represented {nⱼ⁽ⁱ⁾}. The variable j counts the number of necessary split procedures. For Jᵢ−1 split procedures there are Jᵢ lattice codevector indexes.

For a given sub-band i, the information which needs to be transmitted consists of the exponents of the scale factors {sᵢ}, the lattice codevector indexes {Iⱼ⁽ⁱ⁾} and the information related to the number of bits on which the lattice codevector indexes are represented {nⱼ⁽ⁱ⁾}.

The codevectors are indexed (208) in indexing unit 112. The number of bits on which the lattice codevector indexes are represented and the scale factor exponents are entropy encoded (210) in entropy coder 112. This may be done using a Shannon Code or an arithmetic coder to name some examples. The special character corresponding to the split is encoded within the encoder using the number of bits on which the lattice codevectors are represented.

The bit allocation in sub-bands for the scale factors and the number of bits used for the codevectors, is done using a constrained optimization algorithm. For example, the exponents {sᵢ} may be chosen from a number of possible integer values. The number of values for {nⱼ⁽ⁱ⁾} may be 24, i.e. integers from −1 to 22. The integer −1 may be the special symbol for the split.

There can be one entropy encoder for the scale factor exponents and one entropy encoder for the number of bits on which the lattice codevectors are represented.

The base b used for the calculation of the scale factors may depend on the available bitrate, which may be set by the user. For bitrates higher or equal 48 kBit/s this base b can be 1.45, and for bitrates lower than 48 kBit/s, the base b can be 2. It is to be understood that other values could be chosen as well, if found to be appropriate. The use of different base values allows for different quantization resolutions at different bitrates. The determination of the exponents {sᵢ} used for the calculation of the scale factors for each sub-band, which may be integers from 0 to a maximum value depending on the base value of the scale factor, will be described further below. If the base is 1.45, the maximum value for the exponents may be 42 and if the base is 2, the maximum value of the exponents may be 22.

In order to determine suitable exponents {sᵢ}, the scaling unit 106 may perform a distortion/bitrate optimization by applying an optimization algorithm.

To this end, the exponents {sᵢ} for each of the sub-bands having a dimension of n can be initialized with └log_{b}\sqrt{AD/n}┘, where AD is the allowed distortion per sub-band. The chosen value can further be several units smaller. The allowed distortion can be obtained from the underlying perceptual model. └·┘ represents the integer part, or the closest smaller integer to the argument.

For each sub-band SBᵢ, up to 20 (as an example, different values are possible) exponent values can be selected for evaluation. These exponents comprise the 19 exponent values larger than the initial one, plus the initial one. If there are not 20 exponent values larger than the initial value, then only those available are considered. It has to be noted that these numbers can also be changed, but if more values are considered the encoding time increases. Reciprocally, the encoding time could be decreased by considering fewer values, with a slight payoff in coding quality.

For each sub-band and for each considered exponent, a respective pair of bitrate and error ratio can be obtained. This pair is also referred to as rate-distortion measure.

For each sub-band the rate-distortion measures can be sorted such that the bitrate is increasing. Normally, as the bitrate increases, the distortion should decrease. In case this rule is violated, the distortion measure with the higher bitrate can be eliminated. This is why not all the sub-bands have the same number of rate-distortion measures.

The exponent value of the scale factor can be optimized using an optimization method. The goal of the optimization method is to choose the exponent value out of the considered exponent values, for each sub-band of a current frame, such that the cumulated bitrate of the chosen rate-distortion measures is less than or equal to the available bitrate for the frame, and the overall error ratio is as small as possible. The optimization algorithm has two types of initializations.
1. Starting with the rate-distortion measures corresponding to the lowest error ratios, which is equivalent to the highest bitrates, or
2. Starting with the rate-distortion measure that corresponds to an error ratio less than 1.0 for all the sub-bands.

The criterion used for this optimization is the error ratio which should be minimal, while the bitrate should be within the available number of bits given by the bit pool mechanism like in AAC.

According to an exemplary optimization algorithm, the rate-distortion measures are ordered with increasing value of bitrate along the sub-bands i, i=1:N, from 1 to R_{i,Ni} and consequently decreasing error ratio, D_{i,j} i=1:N, j=1:Ni. The algorithm is initialized with the rate-distortion measures having a minimum distortion. The initial bitrate is

$$R = {\sum }_{i}^{n} {R}_{i , Ni} .$$

For selecting the best rate-distortion distortion measure with index k, the following pseudo code can be applied:

| | |
|---|---|
| For i=1:N | k(i) = Ni |

| | |
|---|---|
| 1. | If R < Rₘₐₓ Stop |

| | |
|---|---|
| 2 | Else |

While (1)

| | |
|---|---|
| 4 | For i = 1:n |

| | |
|---|---|
| 5 | If k(i) > 1 |

Grad(i) = (R_{i,k(i)} −R_{i,k(i)-1})/(D_{i,k(i)-1} − D_{i,k(i)}));

| | End For |
|---|---|
| 8 | i_change = arg(max(Grad)); |
| 9 | R = R − Rᵢ_{_{—}}_{change, k(i}_{_{—}}_{change)} + |
| | Rᵢ_{_{—}}_{change, k(i}_{_{—}}_{change)-1} |
| 10 | k(i_change) = k(i_change)−1; |
| 11 | If R < Rₘₐₓ Stop, Output k |

| | |
|---|---|
| 12 | End While |

The indexes k(i), i=1:N, point to a rate-distortion measure, but also to an exponent value that should be chosen for each sub-band, which is the one that may be used to engender the rate-distortion measure.

For high bitrates, e.g. >=48 kbits/s, the algorithm can be modified at line 5 to

if k(i)>2

such that the sub-band i is not considered at the maximization process if, by reducing its bitrate, all the coefficients are set to zero and the bitrate for that sub-band becomes 1.

If the total bitrate is too high, it should be decreased somehow, therefore, some of the sub-bands should have a smaller bitrate. If the only rate-distortion measure available for one sub-band is the one with bitrate equal to 1—which is the smallest possible value for the bitrate of a sub-band, corresponding to all the coefficients in that sub-band being set to zero −, then in that sub-band the bitrate cannot be further decreased. This is the reason for the test if k(i)>1. For each eligible sub-band, the gradient corresponding to the advancement of one pair to the left is calculated, and the one having maximum decrease in bitrate with lowest increase in distortion is selected. Then, the resulting total bitrate is checked, and so on.

Alternatively, the constrained optimization algorithm may be performed by choosing a criterion with an error measure and a bitrate measure as:

$$J = {\sum }_{i = 1}^{N} ( {D}_{i} + λ ( B ( {\{ {n}_{j}^{( i )} \}}_{j} ) + B ( {\{ {I}_{j}^{( i )} \}}_{j} ) + B ( {s}_{i} ) ) ) )$$

where N is the number of sub-bands, Dᵢ is the error ratio signifying the ratio between the sub-band Euclidean distortion and the allowed distortion for the sub-band i, B( ) is the number of bits used for encoding the corresponding parameters of the sub-band i and λ is a Lagrangian multiplier.

The bitrate measure consists of the number of bits needed to encode the sub-band, given the proposed encoding method. The optimization with respect to the error criterion is constrained by the bitrate, i.e. the sum of the bitrate per sub-band should not exceed the available number of bits for the frame. Therefore, by using the Lagrangian multiplier method, the bitrate is inserted in the criterion such that the constrained optimization problem is reduced to a non-constrained one.

The perceptual model gives for each sub-band an allowed quantization distortion value that, due to masking effects, should not affect the auditory perception of the resulting signal. The quantization error in each sub-band should thus be less than the allowed distortion in the corresponding sub-band, therefore the ratio between the quantization error and the allowed distortion is considered.

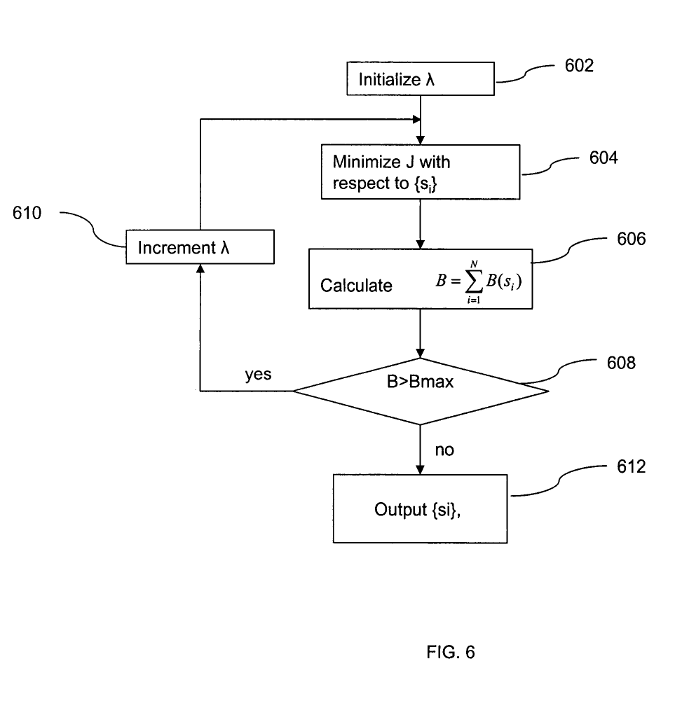

To resolve the optimization criterion, a method as illustrated in FIG. 6 is provided. For each of the sub-bands, encoding is done independently and the counters for the entropy coding are updated once per frame.

As illustrated in FIG. 6, the multiplier λ may be initialized (602) for a given sub-band. The initialization value may be 0.000001.

Then, for a given λ, the scale factor for each sub-band is chosen from the set of possible values, larger than the initial value, such that it minimizes (604) the error ratio J per sub-band. The initial value for the scale factor can be chosen to be the highest integer less than log₂ADᵢ, └log₂ADᵢ┘, where ADᵢ is the allowed distortion given by the perceptual model for the sub-band i.

For a given scale factor, the number of bits B for encoding is calculated (606).

Then the number of bits needed for encoding is compared to a threshold value (608). If the number of bits exceeds a threshold value Bₘₐₓ, the Lagrangian multiplier λ is increased (610) by a certain value, e.g. by 0.0001. The steps 604-610 are repeated until the number of bits per frame is lower than the threshold value, and the scale factor sᵢ is put out (612).

The output bitstream 116 is formed by the succession of the binary codes for {nⱼ⁽ⁱ⁾}, {Iⱼ⁽ⁱ⁾}, and {sᵢ}, from which {nⱼ⁽ⁱ⁾}, and {sᵢ} may be entropy encoded.

The quantized spectral components of each sub-band can be represented by a respective lattice vector. The lattice vector quantizer can be a conditional split lattice vector quantizer.

FIG. 3 illustrates in more detail a conditional split vector quantization step (206). The conditional split quantization is a structured vector quantizer method allowing the reduction of the complexity of the encoding process. The conditional split lattice vector quantizer provides recursive split lattice quantization when required by the input data.

The split lattice quantizers 108 can be built using a lattice containing points of the n-dimensional space. A finite truncation of the lattice forms a ‘codebook’ and one point can be named ‘codevector’. Each codevector can be associated to a respective index. The quantized spectral components of a respective sub-band can be represented by a vector corresponding to a particular codevector of a lattice quantizer. Thus, instead of encoding each vector component separately, a single index may be generated from the lattice and sent for the vector.

In a truncated lattice, the number of points of the lattice is limited. The lattice codevectors are then the points from the lattice truncation.

The main lattice of the quantizer 108 can be a high dimensional lattice, preferably an infinite lattice. A lattice Zₙ can be used for exemplification, but the application can be easily extended for use with other lattices. For a given input data, a point from the infinite lattice, closest to the input is chosen. This point needs to be encoded by means of an integer index {Iⱼ⁽ⁱ⁾} represented by a number of bits {nⱼ⁽ⁱ⁾} that is sent as side information.

In case the chosen lattice point is outside a specified truncation of the lattice, the high dimensional lattice point can be split into two lower dimensional lattice points. The use of the split can be signaled as a specific character within the bitstream of the side information. The possibility of the split continues recursively until a lowest predefined dimension, where the nearest neighbor of the input data is searched within the corresponding truncated lattice.

Given the input data dimension as n, the pre-defined settings of the method are the admissible input space dimensions and the splitting rules for each dimension value.

For instance, a scheme allowing eight possible dimension values n has been implemented. The dimension values may be: 4, 8, 12, 16, 20, 24, 28, and 32. These dimensions can be splitted as 32=16+16, 28=12+16, 24=12+12, 20=4+16; 16=8+8, 12=8+4, and 8=4+4.

For each dimension there may exist a pre-defined truncated lattice, specified by a given number of leader vectors. A truncated lattice can be defined as a union of leader classes. A leader class can be a set of signed permutations, possibly with some constraints, of a given leader vector. The components of the leader vector are positive and ordered in decreasing manner from left to right. For instance a leader vector of a 3-dimensional Z₃ lattice can be (2, 0, 0) and the vectors from the leader class engendered by it are (+/—2, 0, 0), (0, +/−2, 0), (0, 0, +/−2). All the vectors from a leader class have the same ||·||ₚ norm.

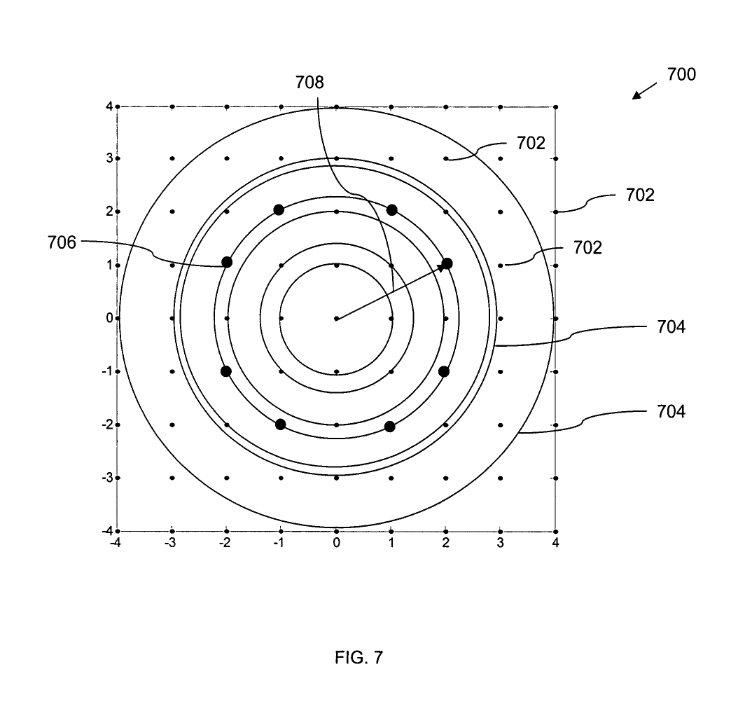

As shown in the FIG. 7, an infinite lattice 700 consists of the lattice points 702. The lattice points 702 can be grouped in sets 704, named shells, of points having the same norm (Euclidean norm in the figure). The sets 704 are formed by one or more leader classes 706. The leader classes 706 are sets of points, which have the same components in absolute value, but different positions and signs for the components. In FIG. 7 a set formed by one leader class with the components (+/−2, +/−1)^{·} and (+/−1, +/−2) is illustrated. One leader vector 708 of the class is depicted. This vector 708 can be used to generate all the other points from the leader class 706. The notion of leader vector is used for the nearest neighbor (NN) search algorithm as well as at the indexing algorithm.

The shape of the pre-defined truncation can be given by the contour of equiprobability of the input data. For instance, for Generalized Gaussian data with shape factor equal to 0.5 the truncation norm can be the || ||_{0.5} norm.

The leader vectors, or at least their non-zero components, should be stored. Generally, if the truncation norm of the smallest dimension is large enough, the leader vectors for the higher dimensions can be easily inferred from the smallest dimension leader vectors, reducing thus the storage requirements. Like indexing algorithms are known from “Indexing algorithms for Zₙ, Aₙ, Dₙ, and Dₙ⁺⁺ lattice vector quantizers”, Rault, P.; Guillemot, C.; Multimedia, IEEE Transactions on Volume 3, Issue 4, December 2001 Page(s):395-404.

The input n-dimensional data x is first quantized (302) to the nearest neighbor NN(x) in the infinite lattice and then NN(x) is further encoded.

If NN(x) belongs to the pre-defined lattice truncation (304) corresponding to the n-dimensional space, an integer index Iₙ is assigned to NN(x) (306).

If NN(x) does not belong to the pre-defined truncation then a split operation is performed (308) according to the splitting rule for that dimension and the symbol ‘−1’ is entropy encoded. Since the input dimension is known as well as the splitting rules, the value of the dimension is easily deduced. After the split operation (308), the split vectors are fed back to the test if the split vectors NN₁, NN₂ belong to the pre-defined lattice truncation (304). The steps 304, 308 are carried out recursively until all split vectors are within the pre-defined lattice truncation.

The overall recursive encoding function can be summarized by the following pseudo-code:

recursive_encode (NN(x), n, x)
{
if NN(x) is in pre-defined n-dimensional truncation

entropy encode the number of bits used for the index

on NN(x)

encode NN(x) in index Iₙ

return
else
if n is the smallest dimension

look for the NN′ (x) in the pre-defined truncation
entropy encode the number of bits used for the index

on NN′ (x)

encode NN′ (x) in index Iₙ

return
else
entropy encode the “split” character
recursive_encode (NN₁(x), n₁, x₁)
recursive_encode (NN₂(x), n₂, x₂)
}

where: n=n₁+n₂ is the split rule for dimension n, NN_{1·}(x) and NN₂(x) are the first n₁ components of NN(x) and the last n₂ components of NN(x), respectively and x₁ and x₂ are the first n₁ components of x and the last n₂ components of x, respectively.

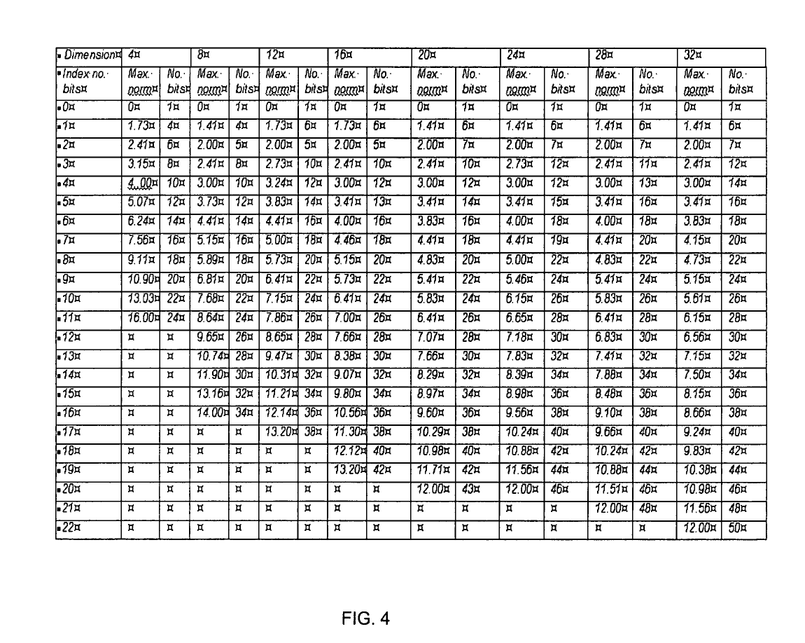

The index of the number of bits needed to encode Iₙ is entropy encoded. The index of the number of bits can be determined from FIG. 4.

For a given dimension, if the ||||_{0.5} norm of NN(x) is less than ‘Max. norm’ from row ‘i’ and larger than ‘Max norm’ from row ‘i−1’ then the symbol ‘i’ will be entropy encoded, using, for instance, a Shannon-Fano code, to specify the number of bits ‘No. bits’.

‘Max norm’ from FIG. 4 can be pre-calculated by the squared root of the ||||_{0.5} norm, in order to avoid supplementary multiplications.

There is a small number of symbols (integers from −1 up to 22) used to encode the number of bits employed for the codevectors indexes Iₙ, which makes the entropy coding very fast.

The splitting procedure forms a binary tree, which is read as root, left branch, right branch in order to form the bitstream. For instance, if there is no split (zero depth tree) the number of bits for I⁽ⁱ⁾, followed by Iₙ is encoded, if there is one split (depth 1 tree) the split character (−1) is encoded for the root and then the number of bits for I₁⁽ⁱ⁾, followed by I₂⁽ⁱ⁾ (the right branch) and the number of bits for I₁⁽ⁱ⁾, followed by I₂⁽ⁱ⁾ (left branch) are encoded. If there are supplementary levels of split, the depth of the tree increases and the tree is read following the same rule.

If, for a given sub-band, there is no split and the number of bits to encode the lattice codevector is zero (corresponding to the all zero vector) then the scale factor exponent is no longer encoded, because it does not make sense to encode a scale for a null vector.

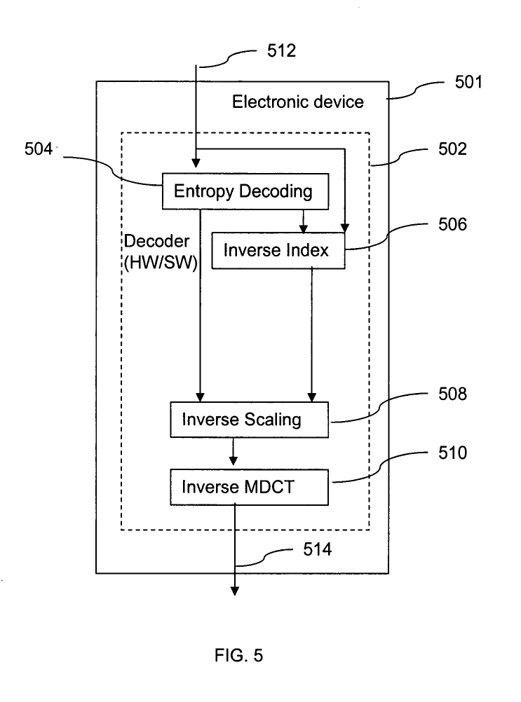

FIG. 5 is a diagram of an exemplary electronic device 501, in which a low-complexity decoding according to an embodiment of the application may be implemented.

Electronic devices 101 and 501 may form together an exemplary embodiment of a system according to the application.

The electronic device 501 comprises a decoder 502, of which the functional blocks are illustrated schematically. The decoder 502 comprises an entropy decoder 504, an inverse indexation unit 506, an inverse scaling unit 508, and an inverse MDCT unit 510.

An encoded bitstream 512 is received within the decoder 502. First, the number of bits of the lattice codevectors, and the exponent of the scaling factor are extracted by the entropy decoding unit 504. If a split symbol is encountered from the decoded bitstream, then a split in the codevector is assumed and the following symbols are the number of bits of the lower dimension lattice codevectors, or a further split symbol is encountered and there is another split.

If the number of bits is zero, the entropy decoding of the scale factor exponent is skipped, otherwise it is decoded with the corresponding decoder. A number of bits equal to the decoded number of bits is read from the bitstream and interpreted as index from the corresponding sub-band vector/part of vector.

From the entropy decoding unit 504 the decoded number of bits is fed to the inverse indexation unit 506 informing on how many bits the index is represented. The codevector index is read from the binary bitstream having a length given by the decoded number of bits and fed to the inverse indexing unit 506. The deindexing procedure is applied in order to obtain the lattice vector. The vector obtained after the inverse indexing is inverse scaled in inverse scaling unit 508 and then an inverse MDCT is applied in inverse MDCT unit 510 obtaining the desired audio signal 514.

The decoder 502 can be implemented in hardware (HW) and/or software (SW). As far as implemented in software, a software code stored on a computer readable medium realizes the described functions when being executed in a processing unit of the device 501.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. It should also be recognized that any reference signs shall not be constructed as limiting the scope of the claims.

What is claimed is:

1. A method for encoding an input audio signal with
receiving the input audio signal,
transforming the time domain audio signal into a frequency domain signal,
splitting the frequency domain audio signal into at least two sub-bands,
scaling the at least two sub-bands with a scaling factor,
quantizing the scaled sub-bands using a conditional split lattice quantizer, wherein the output of the conditional split lattice quantizer is a lattice codevector for each sub-band, and
encoding at least information relating to the scaling factor and information relating to the number of bits on which the lattice codevectors are represented.

2. The method of claim 1, further comprising allocating a number of bits for encoding the sub-band to each respective sub-band by optimizing a constrained error criterion including at least one error measure and at least one bitrate measure.

3. The method of claim 2, wherein the error measure signifies the ratio between a distortion within a sub-band and the allowed distortion for the respective sub-band.

4. The method of claim 2, further comprising determining a scale factor for each sub-band such that it minimizes the error measure per sub-band.

5. The method of claim 2, further comprising selecting the highest integer less than log₂ADᵢ (└log₂ADᵢ┘) as the initial value for the scale factor, where ADᵢ is an allowed distortion given by a perceptual model for the corresponding sub-band.

6. The method of claim 2, further comprising increasing a Lagrangian multiplier for the bitrate measure of the constrained error criterion until the number of bits per frame is below a threshold value.

7. The method of claim 1, wherein the scaling factor comprises a base and an exponent, wherein said exponent is set such that the total bitrate of the encoded audio signal is as close as possible to an available bitrate, and that an overall error ratio in all sub-bands is minimized.

8. The method of claim 1, wherein encoding at least the information relating to the scaling factor exponent and information relating to the number of bits on which the lattice codevectors are represented comprises entropy encoding.

9. The method of claim 8, wherein entropy encoding comprises encoding using at least one of
A) a Shannon-Code, or
B) an arithmetic coding.

10. The method of claim 1, wherein quantizing the scaled sub-bands using a conditional split lattice quantizer comprises searching a point in an infinite lattice closest to the input value from the sub-band.

11. The method of claim 10, wherein quantizing the scaled sub-bands using a conditional split lattice quantizer comprises splitting the found lattice point within the infinite lattice into two lower dimensional lattice points if the found lattice point is outside a truncated lattice with defined truncation limits within the infinite lattice.

12. The method of claim 11, further comprising recursively splitting the found lattice point until the resulting lattice points are within a predefined truncation of the corresponding dimension.

13. The method of claim 11, further comprising building a split level tree where each level represents one split step.

14. The method of claim 11, further comprising signaling the use of a split as a special character.

15. An encoder comprising
a transform unit adapted to receive a time domain input audio signal, to transform the audio signal into a frequency domain signal, and to split the frequency domain audio signal into at least two sub-bands,
a scaling unit adapted to scale at least two sub-bands with a scaling factor,
a conditional split lattice quantizer unit adapted to quantize the scaled sub-bands outputting a lattice codevector for each sub-band, and
an encoding unit adapted to encode at least information relating to the scaling factor and information relating to the number of bits on which the lattice codevectors are represented.

16. The encoder of claim 15, wherein the scaling unit is further adapted to determine a scale factor for each sub-band such that it minimizes the error measure per sub-band.

17. The encoder of claim 15, wherein the conditional split lattice quantizer unit is further adapted to search a point in an infinite lattice closest to the input value from the sub-band for quantization.

18. The encoder of claim 17, wherein the conditional split lattice quantizer unit is further adapted to split the found lattice point within the infinite lattice into two lower dimensional lattice points if the found lattice point is outside a truncated lattice with defined truncation limits within the infinite lattice.

19. The encoder of claim 18, wherein the conditional split lattice quantizer unit is further adapted to recursively split the found lattice point until the resulting lattice points are within a predefined truncation of the corresponding dimension.

20. An electronic device comprising
a transform unit adapted to receive a time domain input audio signal, to transform the audio signal into a frequency domain signal, and to split the frequency domain audio signal into at least two sub-bands,
a scaling unit adapted to scale at least two sub-bands with a scaling factor,
a conditional split lattice quantizer unit adapted to quantize the scaled sub-bands outputting a lattice codevector for each sub-band, and
an encoding unit adapted to encode at least information relating to the scaling factor and information relating to the number of bits on which the lattice codevectors are represented.

21. A software program product, in which a software code for audio encoding is stored, said software code realizing the following steps when being executed by a processing unit of an electronic device:
receive the input audio signal,
transform the time domain audio signal into frequency domain,
split the frequency domain audio signal into at least two sub-bands,
scale the at least two sub-bands with a scaling factor,
quantize the scaled sub-bands using a conditional split lattice quantizer, wherein the output of the conditional split lattice quantizer is a lattice codevector for each sub-band, and
encode at least information relating to the scaling factor and information relating to the number of bits on which the lattice codevectors are represented.

22. A method for decoding an encoded audio signal with
receiving the encoded audio signal,
entropy decoding the encoded audio signal obtaining at least information about the number of bits of lattice codevectors and scaling factors of sub-bands,
obtaining, for each sub-band, a codevector index from an encoded bitstream codeword whose length equals the number of bits of the lattice codevector and obtaining the lattice codevector from the codevector index,
re-scaling, for each sub-band, the obtained codevector by applying the scaling factor and obtaining the frequency representation of the audio signal, and
inverse transforming the frequency representation of the signal into time domain.

23. A decoder comprising
an entropy decoding unit adapted to entropy decode an encoded audio signal obtaining at least information about the number of bits of lattice codevectors and scaling factors of sub-bands,
an inverse indexing unit arranged to obtain, for each sub-band, a codevector index from an encoded bitstream codeword of length equal to the number of bits of the lattice codevector and to obtain the lattice codevector from the codevector index,
a scaling unit adapted to re-scale, for each sub-band, the obtained codevector by applying the scaling factor, and
an inverse transform unit to transform the frequency representation of the signal into time domain.

24. An electronic device comprising
an entropy decoding unit adapted to entropy decode an encoded audio signal obtaining at least information about the number of bits of lattice codevectors and scaling factors of sub-bands,
an inverse indexing unit arranged to obtain, for each sub-band, a codevector index from an encoded bitstream codeword of length equal to the number of bits of the lattice codevector and to obtain the lattice codevector from the codevector index,
a scaling unit adapted to re-scale, for each sub-band, the obtained codevector by applying the scaling factor, and
an inverse transform unit to transform the frequency representation of the signal into time domain.

25. A software program product, in which a software code for audio decoding is stored, said software code realizing the following steps when being executed by a processing unit of an electronic device:
receive the encoded audio signal,
entropy decode the encoded audio signal to obtain at least information about the number of bits of lattice codevectors and scaling factors of sub-bands,
obtain, for each sub-band, a codevector index from an encoded bitstream codeword whose length equals the number of bits of the lattice codevector and obtain the lattice codevector from the codevector index,
re-scale, for each sub-band, the obtained codevector by applying the scaling factor and obtain the frequency representation of the audio signal, and
inverse transform the frequency representation of the signal into time domain.
